(19) United States
(12) Patent Application Publication
(10) Pub. No.: US 2026/0094611 A1
(43) Pub. Date: Apr. 2, 2026

(54) DATA PROCESSING METHOD, MAIN PROCESSING UNIT, CHIP SYSTEM AND APPARATUS

(71) Applicant: Beijing Zitiao Network Technology Co., Ltd., Beijing (CN)

(72) Inventor: Peng Hao, Beijing (CN)

(21) Appl. No.: 19/299,819

(22) Filed: Aug. 14, 2025

(30) Foreign Application Priority Data
Sep. 29, 2024 (CN) 202411376579.1

(51) Int. Cl. G10L 19/008; G10L 15/22; G10L 21/0208

(52) U.S. Cl. CPC G10L 19/008; G10L 15/22; G10L 21/0208; G10L 2021/02082

(57) ABSTRACT

A data processing method, a main processing unit, a chip system, an apparatus, a device, a storage medium and a program product are provided. The method includes: at a main processing unit, in response to receiving first speech data for a digital assistant, sending the first speech data to a first co-processing unit associated with the digital assistant to perform processing on the first speech data, the main processing unit being communicatively connected to a plurality of co-processing units including the first co-processing unit, the plurality of co-processing units being respectively configured to perform different processing operations; receiving the processed first speech data from the first co-processing unit; determining encoded speech data based on the processed first speech data; and sending the encoded speech data to the digital assistant.

### CROSS-REFERENCE

This application claims the benefit of Chinese Patent Application No. 202411376579.1, filed on September 29, 2024 and entitled “DATA PROCESSING METHOD, MAIN PROCESSING UNIT, CHIP SYSTEM AND APPARATUS”, the entirety of which is incorporated herein by reference.

### FIELD

Example embodiments of the present disclosure generally relate to the field of computers, and in particular, to a method, a main processing unit, a chip system, an apparatus, a device, a computer-readable storage medium, and a computer program product for data processing.

### BACKGROUND

With the development of information technologies, various smart hardware devices and/or terminal devices may provide various services to people in terms of work and life. For example, applications providing services may be deployed on terminal devices. Terminal devices or applications may provide digital assistant-type functions to users to assist them in using the terminal devices or applications. Users can complete diverse operations through various interactions with the digital assistants. People also expect that smart hardware devices can also provide digital assistant-type functions to assist users in using such smart hardware devices, terminal devices, or applications, thereby providing greater convenience.

### SUMMARY

In a first aspect of the present disclosure, an information processing method is provided. The method includes: at a main processing unit, in response to receiving first speech data for a digital assistant, sending the first speech data to a first co-processing unit associated with the digital assistant to perform processing on the first speech data, the main processing unit being communicatively connected to a plurality of co-processing units including the first co-processing unit, the plurality of co-processing units being respectively configured to perform different processing operations; receiving the processed first speech data from the first co-processing unit; determining encoded speech data based on the processed first speech data; and sending the encoded speech data to the digital assistant.

In a second aspect of the present disclosure, a main processing unit is provided. The main processing unit is configured to perform the method of the first aspect.

In a third aspect of the present disclosure, a chip system is provided. The chip system includes a plurality of co-processing units and a main processing unit of the second aspect, the main processing unit being communicatively connected to the plurality of co-processing units.

In a fourth aspect of the present disclosure, an apparatus for processing information is provided. The apparatus includes: a data scheduling module configured to, in response to receiving first speech data for a digital assistant, send the first speech data to a first co-processing unit associated with the digital assistant to perform processing on the first speech data, the main processing unit being communicatively connected to a plurality of co-processing units including the first co-processing unit, the plurality of co-processing units being respectively configured to perform different processing operations, and receive the processed first speech data from the first co-processing unit; a speech data determining module configured to determine encoded speech data based on the processed first speech data; and a sending module configured to send the encoded speech data to the digital assistant.

In a fifth aspect of the present disclosure, an electronic device is provided. The electronic device includes at least one processing unit; and at least one memory coupled to the at least one processing unit and storing instructions for execution by the at least one processing unit. The instructions, when executed by the at least one processing unit, cause the electronic device to perform the method of the first aspect.

In a sixth aspect of the present disclosure, a computer-readable storage medium is provided. The medium stores a computer program, and when the computer program is executed by a processor, implements the method of the first aspect.

In a seventh aspect of the present disclosure, a computer program product is provided. The computer program product includes a computer program, wherein the computer program, when executed by a processor, implements the method according to the first aspect of the present disclosure.

It should be understood that the content described in this section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference signs indicate the same or similar elements, where:

FIG. 1 illustrates a schematic diagram of an example environment in which embodiments of the present disclosure can be implemented;

FIG. 2 illustrates a schematic architectural diagram of a chip system according to some embodiments of the present disclosure;

FIGS. 3A to 3D illustrate examples of signaling flows for information processing according to some embodiments of the present disclosure;

FIG. 4 illustrates an example of an information processing signaling flow according to some other embodiments of the present disclosure;

FIG. 5 illustrates a flowchart of a method for information processing according to some embodiments of the present disclosure;

FIG. 6 illustrates an example structural block diagram of an apparatus for information processing according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, performing one step “in response to A” does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may include any type of rights subject, such as individuals, businesses, and groups.

For example, in response to receiving an active request of a user, prompt information is sent to the related user to explicitly prompt the related user, and the operation requested to be performed will need to obtain and use the information of the related user, so that the related user can autonomously select whether to provide information to software or hardware such as electronic devices, applications, servers, or storage medium, etc., performing the operation of the technical solution of the present disclosure according to the prompt information.

As an optional but non-limiting implementation, in response to receiving an active request of a related user, a manner of sending prompt information to the related user may be, for example, using a pop-up window, and prompt information may be presented in a text manner in the pop-up window. In addition, the pop-up window may further carry a selection control for the user to select “agree” or “not agree” to provide information to the electronic device.

It may be understood that the foregoing notification and the process of obtaining the user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

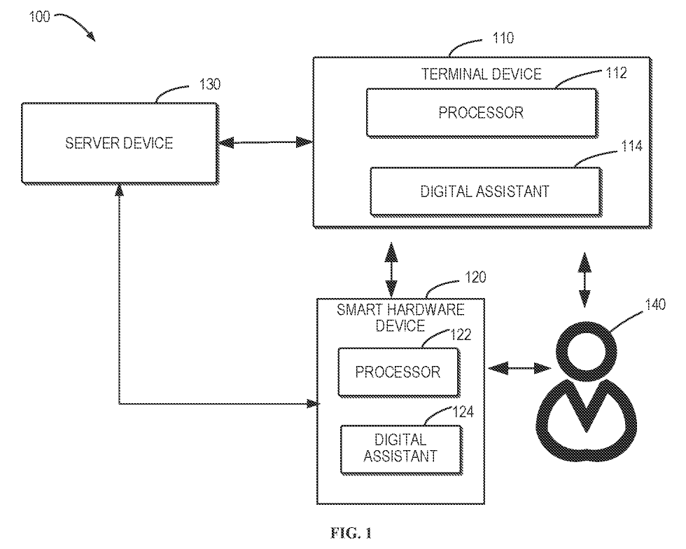

FIG. 1 illustrates a schematic diagram of an example environment 100 in which embodiments of the present disclosure can be implemented. In this example environment 100, a processor 112 and a digital assistant 114 are installed in a terminal device 110, and the digital assistant 114 may be run by the processor 112. The smart hardware device 120 is equipped with a processor 122 and a digital assistant 124, which may be run by the processor 122. The digital assistant 114/124 may assist a user 140 in processing tasks. The digital assistant 114 may have capabilities for conversation with the user and task processing. The digital assistant 124 may have exactly the same functionality as the digital assistant 114, or may have only partial functionality of the digital assistant 114. In some embodiments, the digital assistant 124 is implemented as a helper engine configured to implement a partial function associated with the digital assistant 114, such as wake-up detection.

In the environment 100, the processor 112/122 may include one or more processing units, for example, the processor 112/122 may include an application processor (application processor, AP), a modem processor, a graphics processor (graphics processing unit, GPU), an image signal processor (image signal processor, ISP), a controller, a memory, a video codec, a digital signal processor (digital signal processor, DSP), a baseband processor, and/or a neural network processor (neural-network processing unit,NPU), or the like. Here, different processing units may be independent devices, or may be integrated into one or more processors. Moreover, different processing units may use the same architecture or different architectures. In some embodiments, at least two of the plurality of processing units included in the processor 112/122 use different processor architectures.

In the environment 100, the user 140 may perform an interaction operation through at least one smart hardware device 120, for example, an interaction operation with the terminal device 110. In some embodiments, the smart hardware device 120 may be an attachment device of the terminal device 110, such as earphones and a speaker. In some embodiments, the smart hardware device 120 may also be a wearable device, such as a ring, a watch, a bracelet, a handle, a glove, a finger cuff, glasses, a chest pin, and the like, and may be worn on various parts of the human body. In addition, the wearable device may also be referred to as a wearable interaction device.

In some embodiments, the user 140 may interact with the digital assistant 114 via the terminal device 110 and/or the smart hardware device 120. For example, the user 140 may wake up the digital assistant 114 through the smart hardware device 120 and input speech commands to the smart hardware device 120 to implement interaction with the digital assistant 114. In such embodiments, the smart hardware device 120 is equipped with a sound-collection device, such as a microphone. For another example, a speech reply of the digital assistant 114 may also be provided to the smart hardware device 120 to be played by the smart hardware device 120. In such cases, the smart hardware device 120 may be equipped with an audio output device, such as a speaker.

In some embodiments, the user 140 may also interact with the digital assistant 124 via the smart hardware device 120. The digital assistant 124 may assist the user 140 in processing tasks. The digital assistant 124 may have capabilities for conversation with the user and task processing. For example, the user 140 may wake up the digital assistant 124 through the smart hardware device 120 and input speech commands to the smart hardware device 120 to implement interaction with the digital assistant 124. In such embodiments, the smart hardware device 120 is equipped with a sound-collection device, such as a microphone. For another example, the speech reply of the digital assistant 124 may also be provided to the smart hardware device 120 to be played by the smart hardware device 120. In such cases, the smart hardware device 120 may be equipped with an audio output device, such as a speaker.

In some embodiments, the user 140 may also interact with the digital assistant 114 via the smart hardware device 120 and the digital assistant 124. For example, the user 140 may wake up the digital assistant 114 through the smart hardware device 120 and the digital assistant 124. For example, the speech input to the digital assistant 114 may be received via the smart hardware device 120, and then wake-up detection is performed on the speech input by the digital assistant 124. When the digital assistant 124 detects the preset wake-up word, the received speech input is sent to the digital assistant 114 via the smart hardware device 120 to wake up the digital assistant 114. And then, the received speech command for the digital assistant 114 may be sent to the digital assistant 114 via the smart hardware device 120, and the speech reply associated with the speech command is received from the digital assistant 114, and the speech reply is played. In such embodiments, the smart hardware device 120 is equipped with a sound-collection device, such as a microphone, and an audio output device, such as a speaker.

In some embodiments, the digital assistant 114/124 may utilize a machine learning model (which may include one or more machine learning models) to support the user 140 in controlling the terminal device 110/ smart hardware device 120. For example, digital assistant 114/124 may utilize one or more machine learning models to provide a question answering service to the user 140. It should be understood that the machine learning model may be a different type of model.

In some embodiments, the digital assistant 124 may utilize a machine learning model (which may include one or more machine learning models) to support user 140 to interact with the digital assistant 114. For example, the digital assistant 124 may utilize one or more machine learning models to process speech input received by the smart hardware device 120 for the digital assistant 114, such as echo cancellation, wake-up detection, sound source localization, noise reduction, speech data encoding/decoding, and the like. It should be understood that the machine learning model may be a different type of model.

In some embodiments, the terminal device 110 and/or the smart hardware device 120 communicate with the server device 130 to implement the provision of services to the digital assistant 114/124. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for the user (such as a “wearable” circuit, and so on). The server device 130 may be various types of computing systems/servers capable of providing computing power, including, but not limited to, mainframes, edge computing nodes, computing devices in a cloud environment, and the like.

It should be understood that the structures and functions of the various elements in the environment 100 are described for illustrative purposes only and do not imply any limitation to the scope of the present disclosure.

As mentioned above, the user may complete diverse operations by interacting with a digital assistant. Therefore, people expect that the smart hardware device can also provide a digital assistant function to assist the user in using the smart hardware device, the terminal device, or the application, thereby providing higher convenience for the user. However, current speech interaction technical solutions of smart hardware devices often use single-core or homogeneous multi-core chips. Processing capability of single-core chip is limited, problems such as lag and delay are prone to occur when facing with complex speech tasks, affecting the user experience. Although the homogeneous multi-core chip improves performance to some extent, as the core architecture is the same, it cannot be flexibly optimized for different speech processing tasks, resulting in a low energy efficiency ratio.

Further, the multi-core heterogeneous chip achieves the best balance of performance and power consumption through reasonable task allocation and cooperative work due to the core composition of different types and different performance characteristics, thereby effectively solving the above problems. However, there are some multi-core heterogeneous chips currently, although there are abundant computing resources, components in the chip that facilitate the model calculation related to the digital assistant must be bound to processing cores to be used in the link associated with the music or call scenarios when enabled, leading to the underlying system being unable to support the addition of cross-core link expansion for the third function, bringing great challenges to the development and deployment of the digital assistant link.

In view of this, according to embodiments of the present disclosure, an improved solution for data processing is provided. According to the solution of embodiments of the present disclosure, at the main processing unit, in response to receiving first speech data for the digital assistant, the first speech data is sent to a first co-processing unit associated with the digital assistant to perform processing on the first speech data, the main processing unit is communicatively connected to a plurality of co-processing units including the first co-processing unit, the plurality of co-processing units are respectively configured to perform different processing operations. The processed first speech data is received from the first co-processing unit. The encoded speech data is determined based on the processed first speech data; and the encoded speech data is sent to the digital assistant.

In this way, the processing operation related to the digital assistant can be performed by an appropriate co-processing unit, so that the computing power of each processing unit is fully utilized, and the power consumption of the whole machine is reduced. In other words, an algorithm such as wake-up detection and echo cancellation related to the digital assistant can be flexibly deployed on the target core, thereby fully utilizing the computing power and the memory resources on each core to complete the implementation of the function of the digital assistant, and running concurrently with the music and the call function. In addition, compared with a single-core centralized deployment mode, the operation main frequency is reduced, and the power consumption of the whole device is significantly reduced.

Some example embodiments of the present disclosure will be described below with continued reference to the accompanying drawings.

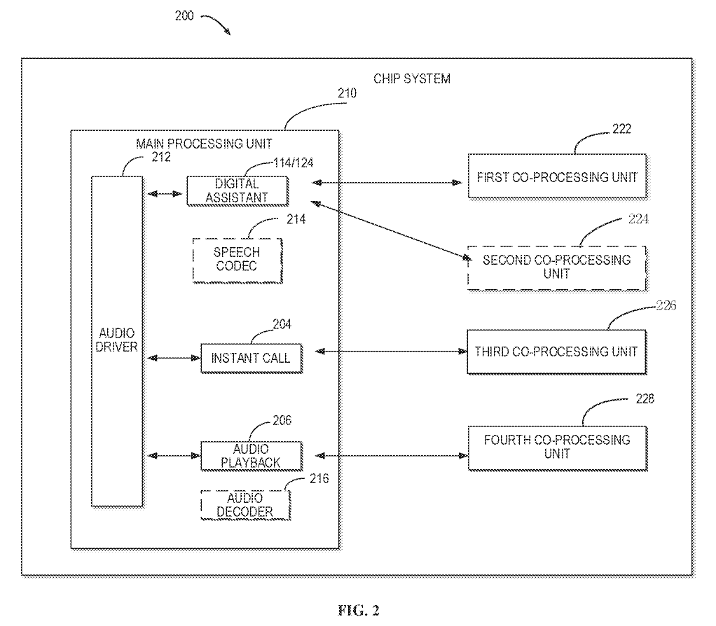

FIG. 2 illustrates a schematic architectural diagram of a chip system 200 according to some embodiments of the present disclosure. For ease of discussion, the chip system 200 will be described with reference to the environment 100 of FIG. 1. The chip system 200 may be implemented at the processor 112 of the terminal device 110 and/or the processor 122 of the smart hardware device 120.

As shown in FIG. 2, the chip system 200 includes a main processing unit 210 (also sometimes referred to as a main control chip) and a plurality of co-processing units (sometimes also referred to as co-processors), for example, may include a first co-processing unit 222, a second co-processing unit 224, a third co-processing unit 226, and a fourth co-processing unit 228. The main processing unit 210 is communicatively connected to the plurality of co-processing units, respectively, e.g., communicatively connected to the first co-processing unit 222, the second co-processing unit 224, the third co-processing unit 226, and the fourth co-processing unit 228, respectively. The main processing unit 210 may communicate with each co-processing unit to transfer data or perform interactive operations with each other. In this context, processing units, cores, or processing cores may be used interchangeably with each other. The chip system 200 includes a plurality of processing units, which may also be referred to as a plurality of cores or a plurality of processing cores. It should be understood that although a number of co-processing units are shown in FIG. 2, in practice the chip system 200 may include any other number of co-processing units.

In some embodiments, the main processing unit 210 may include at least one of an audio driver 212, a speech codec 214, and an audio decoder 216. The audio driver 212 is configured to interact with the sound-collection device (for example, a microphone) or the audio output device (for example, a speaker) of the smart hardware device 120 or the terminal device 110, to receive the speech data or the audio data (which may also be collectively referred to as sound data) from the sound-collection device, originating from a user or an environment, or to play the speech/audio data received from a related application (for example, a digital assistant, a music playing application, an instant messaging application, a video or a teleconference application, etc.) of the smart hardware device 120 or the terminal device 110 via the audio output device.

The speech codec 214 is configured to perform speech encoding or decoding on the speech data received by the main processing unit 210. For example, speech encoding is performed on the speech data input by the user through the sound-collection device (for example, a microphone) of the smart hardware device 120 or the terminal device 110, for example, performing speech encoding (for example, speech encoding algorithm based on an OPUS) on the first speech data from the user for the digital assistant 114/124. For another example, speech decoding is performed on the speech data received from related applications of the smart hardware device 120 or the terminal device 110, for example, speech decoding is performed on second speech data from the digital assistant 114/124, and the second speech data is a reply of the digital assistant 114/124 to the first speech data.

The audio decoder 216 is used to perform audio decoding (e.g., decoding algorithm based on an advanced audio decoding AAC) on the audio data received from the related application of the smart hardware device 120 or the terminal device 110. For example, audio decoding is performed on the audio data from a music playback application.

It should be understood that the above-mentioned OPUS speech encoding and decoding or AAC audio decoding is only an example, and embodiments of the present disclosure may adopt various suitable encoding and decoding formats according to needs, and use a corresponding codec.

In some embodiments, the speech data received from the related application of the smart hardware device 120 or the terminal device 110 may also be processed as the audio data, that is, the speech data may be decoded by the audio decoder 216.

In some embodiments, the plurality of co-processing units and the main processing unit use different processor architectures. For example, the main processing unit 210 may use an ARM core architecture, for example, ARM’s M55 or M33, etc. The first co-processing unit 222 may use a suitable NPU (neural network processor) architecture to deploy algorithms related to neural networks or models on the first co-processing unit 222. The second co-processing unit 224 may use a processor architecture suitable for performing speech decoding. The third co-processing unit 226 may use a processor architecture suitable for performing audio processing. The fourth co-processing unit 228 may use a processor architecture suitable for performing instant call related processing. Herein, different processor architectures or different core architectures may refer to different processing unit sizes and main frequencies, or may refer to different processing unit operation architectures, or may refer to different instruction sets of the processing unit.

In some embodiments, the processor architectures of at least two of the plurality of co-processing units are different from each other. For example, the processor architecture of the first co-processing unit 222 is different from those of the second co-processing unit 224, the third co-processing unit 226 and the fourth co-processing unit 228. For another example, the processor architectures of the first co-processing unit 222 and the second co-processing unit 224 are different, the processor architectures of the third co-processing unit 226 and the fourth co-processing unit 228 are different. Alternatively, the processor architectures of the first co-processing unit 222 and the second co-processing unit 224 are different, the processor architectures of the third co-processing unit 226 and the fourth co-processing unit 228 are the same. For another example, the processor architectures of the first co-processing unit 222, the second co-processing unit 224, the third co-processing unit 226, and the fourth co-processing unit 228 are different from each other.

As described above, since the main processing unit 210 and the multiple co-processing units use different processor architectures, the chip system 200 is also referred to as a heterogeneous multi-core processor, or a heterogeneous multi-core chip.

In some embodiments, the main processing unit 210 and the multiple co-processing units are located on the same integrated circuit. In other words, the main processing unit 210 and the multiple co-processing units belong to different processing units in the same chip, rather than belonging to different chips.

In some embodiments, the main processing unit 210 may be used as a main control chip, responsible for executing a general task or a majority of tasks of the smart hardware device 120 or the terminal device 110. The first co-processing unit 222, the second co-processing unit 224, the third co-processing unit 226, and the fourth co-processing unit 228 are respectively responsible for different types of specific tasks. In this way, each processing unit can execute a suitable task, so that the working main frequency of each processing unit is ensured to be at a low power consumption level by the allocation of computing power, thereby achieving the goal of controllable power consumption of the whole machine.

In some embodiments, the main processing unit 210 may be responsible for cross-core scheduling among the various co-processing units, so as to schedule different computing tasks or processing tasks on different co-processing units to perform processing, so that different types of tasks can be efficiently processed by using a suitable processing unit. For example, the main processing unit 210 may schedule tasks or data between the main processing unit 210 and each co-processing unit through a framework of cross-core data interaction (Multi-Core PCM Processing, hereinafter referred to as MCPP).

In some embodiments, the chip system 200 may be configured to implement functional modules such as the digital assistant 114/124, the instant call 204 and the audio playback 206. The digital assistant 114/124, the instant call 204 and the audio playback 206 respectively process corresponding data, such as speech data or audio data, through respective corresponding links in the chip system 200. For example, the functionality of the digital assistant 114/124 may be implemented by processing the relevant speech data for the digital assistant 114/124 through the audio driver 212, the speech codec 214, the first co-processing unit 222, and/or the second co-processing unit 224. The instant call 204 is implemented by performing processing on speech data related to the instant call through the audio driver 212 and the third co-processing unit 226. The audio playback 206 is implemented by the audio driver 212, the audio decoder 216, and the fourth co-processing unit 228 performing processing on the audio data.

In some embodiments, the first co-processing unit 222 may be configured to perform tasks related to the digital assistant, for example, to perform processing on the speech data for the digital assistant, such as echo cancellation, wake-up detection, sound source localization, and the like. The second co-processing unit 224 may be configured to perform tasks related to the digital assistant, such as performing speech encoding or speech decoding on the speech data for the digital assistant. The third co-processing unit 226 may be used to perform tasks related to audio processing, such as audio data decoding, adjusting EQ (equalizer), DRC (dynamic range) of audio data, etc. The fourth co-processing unit 228 may be configured to perform tasks related to the instant call, including but not limited to processing such as call noise reduction.

It should be noted that the encoding/decoding of the speech data for the digital assistant may be implemented at the main processing unit 210 (i.e., the speech codec 214) or at the second co-processing unit 224. In other words, if the codec process is performed on the speech data by the speech codec 214 at the main processing unit 210, the chip system 200 may not configure the second co-processing unit 224 for the digital assistant. If the codec processing is performed on the speech data through the second co-processing unit 224, the speech data codec 214 is not configured at the main processing unit 210 (i.e., the corresponding speech data codec module or algorithm is not configured).

It should also be noted that for audio decoding, that is, the audio decoder 216 may be implemented at the main processing unit 210 or at the third co-processing unit 226. For example, audio decoding may be performed by the main processing unit 210, or may be performed by the third co-processing unit 226. In other words, if the decoding process is performed on the audio data by the main processing unit 210 (i.e., the audio decoder 216), an algorithm or module related to audio decoding may not be configured at the third co-processing unit 226. If the decoding process is performed on the audio data by the third co-processing unit 226, the audio decoder 216 (i.e., an algorithm or module related to audio decoding) may not be configured at the main processing unit 210.

It should be understood that the functions of the respective co-processing units described above are merely examples, which do not constitute limitations to the present disclosure, and each co-processing unit may be configured to perform various suitable functions or processes according to the architecture and requirements.

In conclusion, in embodiments of the present disclosure, a framework of cross-core data interaction (Multi-Core PCM Processing hereinafter referred to as MCPP) of the multi-chip system 220 may be decoupled from music and call scenarios, so that the digital assistant link independently uses a suitable co-processing unit (for example, an NPU unit) to perform model calculation and interactive link encoding/decoding, thereby achieving efficient execution of related operations of the digital assistant. In this way, the computing tasks required by the call, the music, and the assistant interaction in three scenarios can be distributed on different cores, to avoid generating computing power conflicts. This manner relies on the allocation of computing power, and can also ensure that the working main frequency of each core is at a low power consumption level, thereby achieving the goal of controllable power consumption of the whole machine.

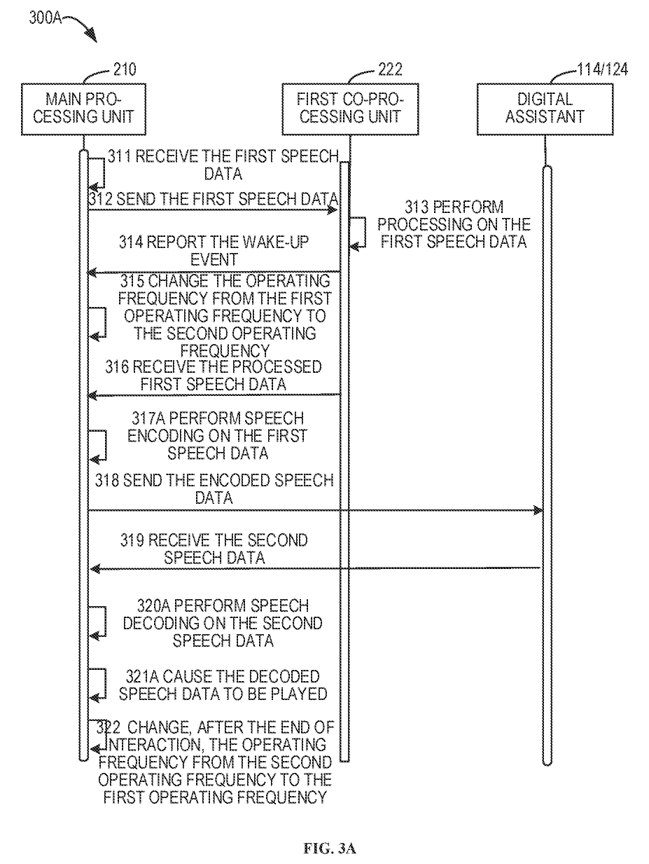

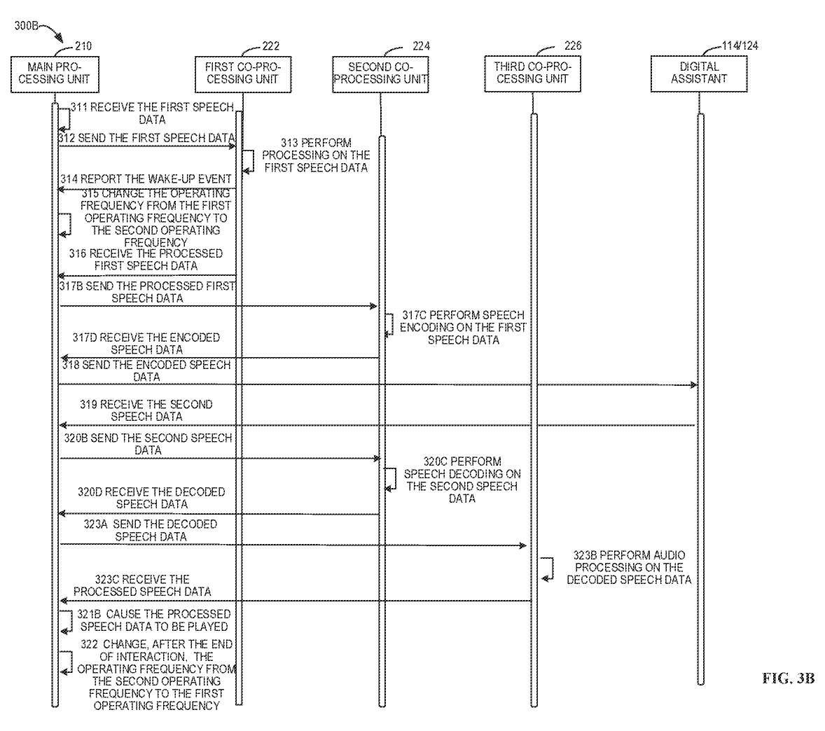

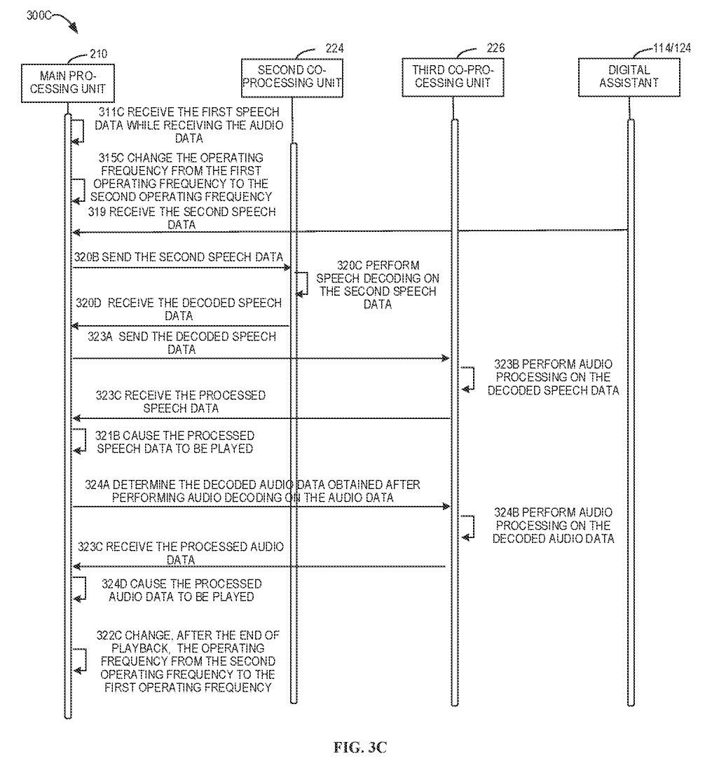

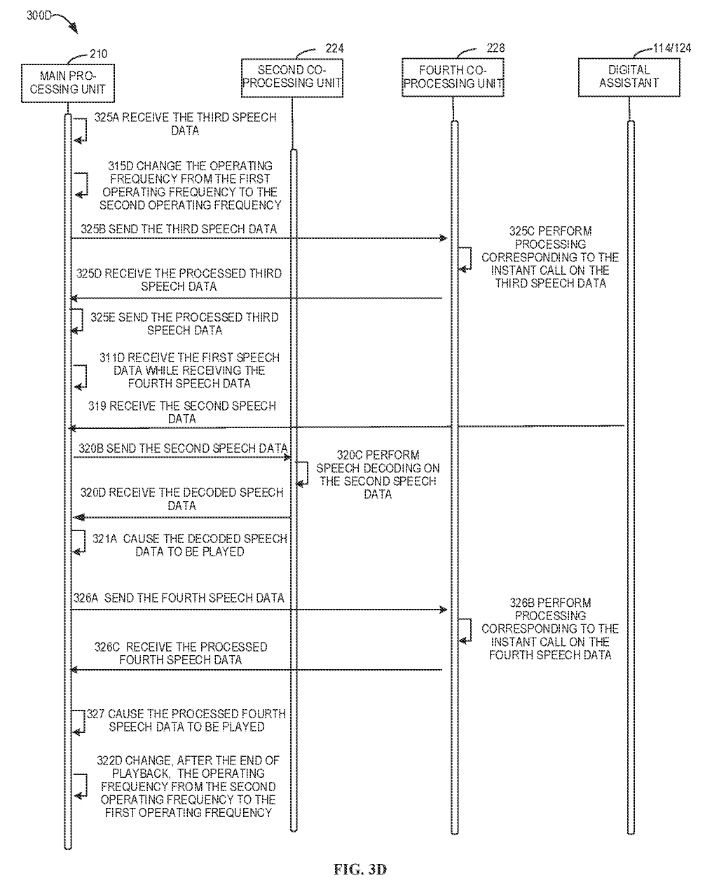

The signaling interaction examples between the processing units in the chip system 200 in embodiments of the present disclosure are described below with reference to FIG. 3A to FIG. 3D.

FIG. 3A illustrates an example of a signaling flow 300A for information processing according to some embodiments of the present disclosure. The signaling flow 300A relates to the terminal device 110, the smart hardware device 120, the main processing unit 210, the first co-processing unit 222, and the digital assistant 114/124.

The main processing unit 210 of the terminal device 110 and the smart hardware device 120 may receive (311) the first speech data for the digital assistant 114/124, where the data is input by the user and received by the sound-collection device. Then, in response to receiving the first speech data, the first speech data is sent (312) to the first co-processing unit 222 associated with the digital assistant 114/124 to perform processing on the first speech data.

The first co-processing unit 222 performs processing on the first speech data (313). For example, the first co-processing unit 222 performs echo cancellation, wake-up detection, and/or sound source localization on the first speech data. In some embodiments, the first co-processing unit 222 is configured to report (314) the wake-up event to the main processing unit 210 upon detecting a preset wake-up word.

After receiving the wake-up event, the main processing unit 210 changes (315) the operating frequency of the main processing unit 210 from the first operating frequency to the second operating frequency. The second operating frequency is higher than the first operating frequency. For example, after detecting a wake-up event, the main processing unit 210 increases the main frequency to provide the computing power required to interact with the digital assistant 114/124.

The main processing unit 210 receives (316) the processed first speech data from the first co-processing unit 222 and then performs speech encoding (317A) on the first speech data by a speech codec 214 (e.g., a speech encoder). For example, OPUS encoding is performed on the processed first speech data. The encoded speech data is then sent (318) to the digital assistant 114/124.

The main processing unit 210 receives (319) the second speech data from digital assistant 114/124. The second speech data is a reply of the digital assistant 114/124 to the first speech data. For example, the first speech data is the wake-up word “xxx”, and the second speech data is “Is there anything I can do for you.” For another example, the first speech data is “help me check the weather for tomorrow”, and the second speech data is “tomorrow will be cloudy, and the temperature is 20 degrees... The main processing unit 210 then performs speech decoding (320A) on the second speech data. The main processing unit 210 then causes the decoded speech data to be played (321A). For example, the main processing unit 210 controls the terminal device 110 or the speaker of the smart hardware device 120 to play the second speech data.

After detecting the end of interaction with the digital assistant 114/124, the main processing unit 210 changes (322) the operating frequency of the main processing unit 210 from the second operating frequency to the first operating frequency. For example, after detecting the end of interaction with the digital assistant 114/124, the main processing unit 210 decreases the operating frequency, thereby reducing device power consumption.

It should be understood that the above signaling flow 300A is merely an example, and in an embodiment of the present disclosure, more or fewer signaling flows than those shown in the signaling flow 300A may be included. For example, in a scenario where digital assistant 114/124 has been woken up, 314 and 315 in signaling flow 300A may not be included.

FIG. 3B illustrates an example of a signaling flow 300B of information processing according to some embodiments of the present disclosure. The signaling flow 300B relates to the terminal device 110, the smart hardware device 120, the main processing unit 210, the first co-processing unit 222, the second co-processing unit 224, the third co-processing unit 226, and the digital assistant 114/124.

The main processing unit 210 of the terminal device 110 and the smart hardware device 120 may receive (311) the first speech data for the digital assistant 114/124, where the data is input by the user and received by the sound-collection device. Then, in response to receiving the first speech data, the first speech data is sent (312) to the first co-processing unit 222 associated with the digital assistant 114/124 to perform processing on the first speech data.

The first co-processing unit 222 performs processing (313) on the first speech data. For example, the first co-processing unit 222 performs echo cancellation, wake-up detection, and/or sound source localization on the first speech data. In some embodiments, the first co-processing unit 222 is configured to report (314) the wake-up event to the main processing unit 210 upon detecting a preset wake-up word.

After receiving the wake-up event, the main processing unit 210 changes (315) the operating frequency of the main processing unit 210 from the first operating frequency to the second operating frequency. The second operating frequency is higher than the first operating frequency. For example, upon detecting a wake-up event, the main processing unit 210 increases the main frequency to provide the computing power required to interact with the digital assistant 114/124.

The main processing unit 210 receives (316) the processed first speech data from the first co-processing unit 222, and then sends (317B) the processed first speech data to the second co-processing unit 224 to perform speech encoding on the processed first speech data. For example, OPUS encoding is performed on the processed first speech data.

The second co-processing unit 224 performs speech encoding on the processed first speech data (317C), and sends the encoded speech data to the main processing unit 210.

The main processing unit 210 receives (317D) the encoded speech data, and then sends (318) the encoded speech data to the digital assistant 114/124.

The main processing unit 210 receives (319) the second speech data from digital assistant 114/124. The second speech data is a reply of the digital assistant 114/124 to the first speech data. For example, the first speech data is the wake-up word “xxx”, the second speech data is “Is there anything I can do for you.” For another example, the first speech data is “help me check the weather for tomorrow”, the second speech data is “tomorrow will be cloudy, and the temperature is 20 degrees...”. The main processing unit 210 then sends (320B) the second speech data to the second co-processing unit 224 to perform speech decoding on the second speech data.

The second co-processing unit 224 performs speech decoding on the second speech data (320C), and then sends the decoded speech data to the main processing unit 210.

The main processing unit 210 receives (320D) the decoded speech data. The decoded speech data is then sent (323A) to the third co-processing unit 226 for audio processing.

The third co-processing unit 226 performs audio processing on the decoded speech data (323B), such as adjusting the DRC or dynamic EQ of the decoded speech data. The audio-processed second speech data is then sent to the main processing unit 210.

The main processing unit 210 receives (323C) the processed speech data. Then the main processing unit 210 causes the processed speech data to be played (321B). For example, the main processing unit 210 controls the terminal device 110 or the speaker of the smart hardware device 120 to play the processed second speech data.

After detecting the end of interaction with the digital assistant 114/124, the main processing unit 210 changes (322) the operating frequency of the main processing unit 210 from the second operating frequency to the first operating frequency. For example, after detecting the end of interaction with the digital assistant 114/124, the main processing unit 210 decreases the operating frequency, thereby reducing device power consumption.

It should be understood that the above signaling flow 300B is merely an example, and in an embodiment of the present disclosure, more or fewer signaling flows than those shown in the signaling flow 300B may be included. For example, in a scenario where digital assistant 114/124 has been woken up, 314 and 315 in signaling flow 300B may not be included. As another example, for speech data, 323A- 323D in signaling flow 300B may not be included.

FIG. 3C illustrates an example of a signaling flow 300C for information processing according to some embodiments of the present disclosure. The signaling flow 300C relates to the terminal device 110, the smart hardware device 120, the main processing unit 210, the second co-processing unit 224, the third co-processing unit 226, and the digital assistant 114/124.

The main processing unit 210 of the terminal device 110 and the smart hardware device 120 may receive (311C) the first speech data for the digital assistant 114/124 input by the user while the sound-collection device receives (311C) the audio data from the related applications (for example, a music playback application) of the terminal device 110 and the smart hardware device 120. For example, while playing audio, interacting with the digital assistant 114/124.

Reference may be made to the description in conjunction with 300A and 300B for processing of the first speech data, and details are not described herein again.

The main processing unit 210 changes (315C) the operating frequency of the main processing unit 210 from the first operating frequency to the second operating frequency. The second operating frequency is higher than the first operating frequency. For example, the main processing unit 210 may increase the operating frequency in response to detecting the wake-up event or in response to receiving the audio data to provide the computing power required for interaction with the digital assistant 114/124 or audio playback.

The main processing unit 210 receives (319) the second speech data from digital assistant 114/124. The second speech data is a reply of the digital assistant 114/124 to the first speech data. For example, the first speech data is the wake-up word “xxx”, and the second speech data is “Is there anything I can do for you.” For another example, the first speech data is “help me check the weather for tomorrow ”, and the second speech data is “tomorrow will be cloudy, and the temperature is 20 degrees .... The main processing unit 210 then sends the second speech data (320B) to the second co-processing unit 224 to perform speech decoding on the second speech data.

The second co-processing unit 224 performs speech decoding (320C) on the second speech data, and then sends the decoded speech data to the main processing unit 210.

The main processing unit 210 receives (320D) the decoded speech data. The decoded speech data is then sent (323A) to the third co-processing unit 226 for audio processing.

The third co-processing unit 226 performs audio processing on the decoded speech data (323B), such as adjusting the DRC or dynamic EQ of the decoded speech data. The audio-processed second speech data is then sent to the main processing unit 210.

The main processing unit 210 receives (323C) the processed speech data. Then the main processing unit 210 causes the processed speech data to be played (321B). For example, the main processing unit 210 controls the terminal device 110 or the speaker of the smart hardware device 120 to play the processed second speech data.

The main processing unit 210 determines (324A) decoded audio data obtained after performing audio decoding on the audio data. In some embodiments, the main processing unit 210 performs decoding processing on the audio data to obtain decoded audio data, and sends the decoded audio data to the third co-processing unit 226. In some embodiments, the main processing unit sends the audio data to the third co-processing unit 226, and the third co-processing unit 226 performs audio decoding on the audio data to obtain the decoded audio data.

The third co-processing unit 226 performs audio processing on the decoded audio data (324B). For example, adjusting the DRC or dynamic EQ of the decoded audio data. The audio-processed audio data is then sent to the main processing unit 210.

The main processing unit 210 receives (324C) the processed audio data. Then the main processing unit 210 causes the processed audio data to be played (324D). For example, the main processing unit 210 controls the terminal device 110 or the speaker of the smart hardware device 120 to play the processed audio data.

After detecting the end of the playback of the audio data, the main processing unit 210 changes (322C) the operating frequency of the main processing unit 210 from the second operating frequency to the first operating frequency. For example, after detecting the end of audio playback, the main processing unit 210 decreases the operating frequency, thereby reducing device power consumption.

It should be understood that 324D and 321B may be performed simultaneously, that is, the user may listen to the music while listening to the response from the digital assistant 114/124. Moreover, when the second speech data is played, the audio data may be played simultaneously. Or, when the second speech data is played, the audio data may be paused. Alternatively, when the second speech data is played, the volume of the audio data may be reduced.

It should be understood that the above signaling flow 300C is merely an example, and in an embodiment of the present disclosure, more or fewer signaling flows than those shown in the signaling flow 300C may be included. For example, for speech data, 323A- 323D in signaling flow 300C may not be included.

FIG. 3D illustrates an example of a signaling flow 300D for information processing according to some embodiments of the present disclosure. The signaling flow 300D relates to the terminal device 110, the smart hardware device 120, the main processing unit 210, the second co-processing unit 224, the fourth co-processing unit 228, and the digital assistant 114/124.

The main processing unit 210 of the terminal device 110 and the smart hardware device 120 may receive (325A) third speech data for the instant call (real-time call), input by the user and received through the sound-collection device. For example, receiving the speech data for a speech call or a video conference.

The main processing unit 210 changes (315D) the operating frequency of the main processing unit 210 from the first operating frequency to the second operating frequency. The second operating frequency is higher than the first operating frequency. For example, the main processing unit 210 may increase the operating frequency in response to establishment of the instant call to provide the computing power required for the instant call.

The main processing unit 210 sends (325B) the third speech data to the fourth co-processing unit 228. The fourth co-processing unit 228 performs processing (325C) corresponding to the instant call on the third speech data, for example, noise reduction processing. The processed third speech data is then sent to the main processing unit 210.

The main processing unit 210 receives (325D) the processed third speech data and sends (325E) the processed third speech data to the other party (or peer) of the instant call. For example, via Bluetooth, Wi-Fi, mobile communication, the processed third speech data is directly or indirectly sent to the other party of the instant call . The other party may be one or more parties. The other party refers to the peer of the user (i.e., the local end) of the terminal device 110 or the smart hardware device 120, and the other party or the peer of the instant call.

The main processing unit 210 may also receive (311D) the first speech data for the digital assistant 114/124 while receiving the fourth speech data from the other party of the instant call. The fourth speech data may be a reply from another party to the third speech data or other interactive speech data. For example, the user may interact with the digital assistant 114/124 during a speech call or a video conference.

Reference may be made to the description in conjunction with 300A and 300B for the processing of the first speech data, and details are not described herein again.

The main processing unit 210 receives (319) the second speech data from the digital assistant 114/124. The second speech data is a reply of the digital assistant 114/124 to the first speech data. For example, the first speech data is the wake-up word “xxx”, and the second speech data is “Is there anything I can do for you.” For another example, the first speech data is “help me check the weather for tomorrow ”, and the second speech data is “tomorrow will be cloudy, and the temperature is 20 degrees .... The main processing unit 210 then sends (320B) the second speech data to the second co-processing unit 224 to perform speech decoding on the second speech data.

The second co-processing unit 224 performs speech decoding (320C) on the second speech data, and then sends the decoded speech data to the main processing unit 210.

The main processing unit 210 receives (320D) the decoded speech data. Then the main processing unit 210 causes the decoded speech data to be played (321A). For example, the main processing unit 210 controls the terminal device 110 or the speaker of the smart hardware device 120 to play the decoded second speech data.

The main processing unit 210 sends (326A) the fourth speech data to the fourth co-processing unit 228. The fourth co-processing unit 228 performs processing corresponding to the instant call on the fourth speech data (326B), and then sends the processed fourth speech data to the main processing unit 210.

The main processing unit 210 receives (326C) the processed fourth speech data and then causes the processed fourth speech data to be played (327). For example, the main processing unit 210 controls the terminal device 110 or the speaker of the smart hardware device 120 to play the fourth speech data.

After the instant call ends, the main processing unit 210 changes (322D) the operating frequency of the main processing unit 210 from the second operating frequency to the first operating frequency. For example, after detecting the end of the instant call, the main processing unit 210 decreases the operating frequency, thereby reducing the power consumption of the device.

It should be understood that 321A and 327 may be performed simultaneously, that is, the user may listen to the response from the digital assistant 114/124 while answering the instant call. When the second speech data is played, the fourth speech data may be played simultaneously. Alternatively, when the second speech data is played, the fourth speech data may be paused. Alternatively, when the second speech data is played, the volume of the fourth speech data may be reduced.

The instant call herein refers to a real-time call by an operator call, a speech call application, or a video conference application.

It should be understood that the above signaling flow 300D is merely an example, and in an embodiment of the present disclosure, more or less signaling flows than those shown in the signaling flow 300D may be included. For example, in 315D, it may be included that the main processing unit 210 controls the fourth co-processing unit 228 to be powered on, and in 322D, it may be included that the main processing unit 210 controls the fourth co-processing unit 228 to be powered down.

It should also be understood that FIG. 3A to FIG. 3D are merely signaling flow examples of the chip system 200, and in this embodiment of the present disclosure, the signaling flow of the chip system 200 may include more or less signaling than the signaling flows 300A to 300D, or may combine signaling included in the signaling flows 300A to 300D.

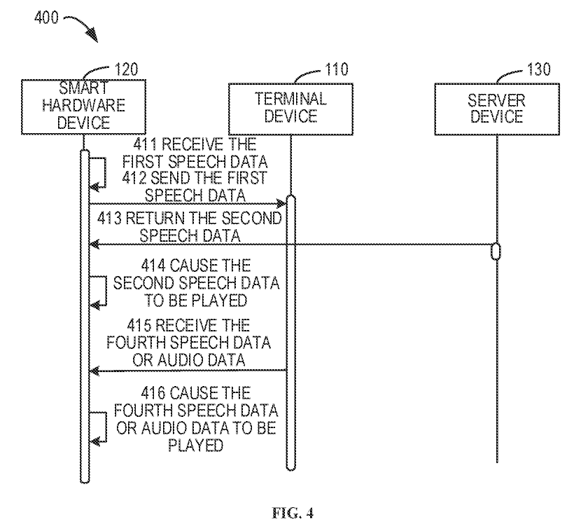

FIG. 4 illustrates an example of a signaling flow 400 for information processing according to some embodiments of the present disclosure. The signaling flow 400 relates to the terminal device 110, the smart hardware device 120, and the server device 130.

The smart hardware device 120 may receive (411) the first speech data for the digital assistant 114 received from the user via the audio input device. The first speech data is sent (412) to the terminal device 110. For processing of the first speech data, refer to the foregoing descriptions of FIG. 3A and FIG. 3B, and details are not described herein again.

The terminal device 110 returns (413) the second speech data. The second speech data may be a reply to the first speech data by the digital assistant 114. The second speech data may be directly obtained from the terminal device 110 and may be obtained from the server device 130.

The smart hardware device 120 may cause the second speech data to be played (414). For example, the smart hardware device 120 may control the speaker to play the second speech data.

The smart hardware device 120 may simultaneously receive (415) the fourth speech data or the audio data. The fourth speech data is speech data of the connecting party of the instant call application from the terminal device 110. The audio data is audio data of a music playback application from the terminal device 110. For example, the user may interact with the digital assistant 114, such as waking up the digital assistant 114, while answering the instant call or listening to music.

The smart hardware device 120 may cause the fourth speech data or audio data to be played (416). For example, the smart hardware device 120 may control the speaker to play the fourth speech data or the audio data. The playing of the fourth speech data or the audio data may be performed simultaneously with the playing of the second speech data. For example, the user may listen to a response from the digital assistant 114 while answering the instant call or listening to music.

It should be understood that the above signaling flow 400 is merely an example, which does not constitute a limitation on the present disclosure. For example, the audio data in 415 may also be from a local music playback application on the smart hardware device 120, rather than a music playback application from the terminal device 110. For another example, the interaction similar to the signaling flow 400 may also be performed only on the terminal device 110 or the smart hardware device 120. For example, on the terminal device 110, interaction occurs with the digital assistant 114 while answering the instant call or listening to music. Alternatively, on the smart hardware device 120, interaction occurs with the digital assistant 124 while answering the instant call or listening to music.

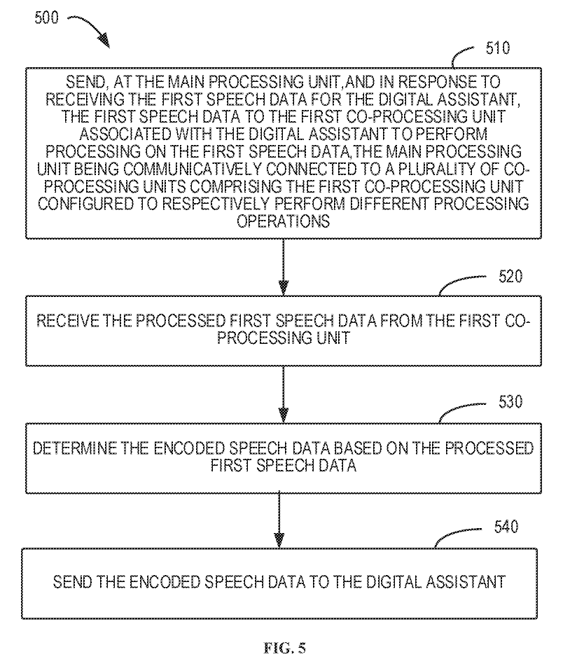

FIG. 5 illustrates a flowchart of a process 500 for data processing according to some embodiments of the present disclosure. For ease of discussion, the process 500 will be described with reference to the environment 100 of FIG. 1 and the chip system 200 of FIG. 2. The process 500 may be implemented at the terminal device 110 and/or the smart hardware device 120, and may be specifically implemented at the main processing unit 210 shown in FIG. 2 included in the terminal device 110 and/or the smart hardware device 120. For ease of description, the process 500 is implemented at the main processing unit 210 as an example for description. Certainly, the main processing unit 210 may be a main processing unit of the processor 112 or 122 of the terminal device 110 and/or the smart hardware device 120.

At block 510, at the main processing unit 210, in response to receiving the first speech data for the digital assistant 114/124, the first speech data is sent to the first co-processing unit 222 associated with the digital assistant 114/124 to perform processing on the first speech data. The main processing unit 210 is communicatively connected to a plurality of co-processing units including the first co-processing unit 222, and wherein these co-processing units are respectively configured to perform different processing operations.

The main processing unit 210 may receive the first speech data through the terminal device 110 or the audio input device of the smart hardware device 120.

In some embodiments, the first co-processing unit 222 is configured to perform echo cancellation, wake-up detection, and/or sound source localization on the first speech data.

At block 520, the main processing unit 210 receives the processed first speech data from the first co-processing unit 222.

At block 530, the main processing unit 210 determines the encoded speech data based on the processed first speech data.

In some embodiments, the second co-processing unit 224 of the plurality of co-processing units is associated with the digital assistant 114/124, and wherein determining the encoded speech data based on the processed first speech data includes: the main processing unit 210 sending the processed first speech data to the second co-processing unit 224 to perform speech encoding on the processed first speech data, the second co-processing unit 224 being different from the first co-processing unit 222; and receiving the encoded speech data from the second co-processing unit 224.

In some embodiments, the first co-processing unit is further configured to report the wake-up event to the main processing unit upon detecting the preset wake-up word, and sending the processed first speech data to the second co-processing unit includes: in response to receiving the wake-up event from the first co-processing unit, sending the processed first speech data to the second co-processing unit.

At block 540, the encoded speech data is sent to the digital assistant 114/124.

In some embodiments, the process 500 further includes: the main processing unit 210 receiving the second speech data for the first speech data from the digital assistant 114/124, the second speech data being a reply of the digital assistant 114/124 to the first speech data; determining the decoded speech data based on the second speech data; and causing the decoded speech data to be played.

In some embodiments, the second co-processing unit 224 of the plurality of co-processing units is associated with the digital assistant 114/124, and determining the decoded speech data based on the second speech data includes: sending the second speech data to the second co-processing unit 224 to perform speech decoding on the second speech data; and receiving the decoded speech data from the second co-processing unit 224.

In some embodiments, the third co-processing unit 226 of the plurality of co-processing units is associated with audio processing, the process 500 further includes: sending the decoded speech data to the third co-processing unit 226 to perform audio processing on the decoded speech data; receiving the processed decoded speech data from the third co-processing unit 226; and causing the processed decoded speech data to be played.

In some embodiments, the process 500 further includes: in response to receiving the audio data while receiving the first speech data for the digital assistant 114/124, determining the decoded audio data obtained after performing audio decoding on the audio data; sending the decoded audio data to the third co-processing unit 226 to perform audio processing on the audio data; receiving the processed audio data from the third co-processing unit 226; and causing the processed audio data to be played.

In some embodiments, the fourth co-processing unit 228 in the plurality of co-processing units is associated with the instant call, and the process 500 further includes: in response to receiving the third speech data for the instant call, sending the third speech data to the fourth co-processing unit 228 to perform processing corresponding to the instant call on the third speech data; receiving the processed third speech data from the fourth co-processing unit 228; and sending the processed third speech data to the receiver of the third speech data.

In some embodiments, the process 500 further includes: in response to receiving the fourth speech data for the instant call while receiving the first speech data for the digital assistant 114/124, sending the fourth speech data to the fourth co-processing unit to perform processing corresponding to the instant call on the fourth speech data; receiving the processed fourth speech data; and causing the processed fourth speech data to be played.

In some embodiments, the process 500 further includes: in response to detecting a start of interaction with the digital assistant 114/124, changing the operating frequency of the main processing unit 210 from the first operating frequency to the second operating frequency, the second operating frequency being higher than the first operating frequency; and in response to detecting an end of interaction with the digital assistant 114/124, changing the operating frequency of the main processing unit 210 from the second operating frequency to the first operating frequency.

In some embodiments, the process 500 further includes: in response to receiving the audio data, changing the operating frequency of the main processing unit 210 from the first operating frequency to the second operating frequency, the second operating frequency being higher than the first operating frequency; and in response to the end of the audio data playing, changing the operating frequency of the main processing unit 210 from the second operating frequency to the first operating frequency.

In some embodiments, the process 500 further includes: in response to detecting a start of the instant call, changing the operating frequency of the main processing unit 210 from the first operating frequency to the second operating frequency, the second operating frequency being higher than the first operating frequency and/or causing the fourth co-processing unit 228 to be powered on; and in response to detecting an end of the instant call, changing the operating frequency of the main processing unit 210 from the second operating frequency to the first operating frequency and/or causing the fourth co-processing unit 228 to be powered down.

In conclusion, according to embodiments of the present disclosure, the multi-core heterogeneous processor may be used to implement the development and deployment of the digital assistant function, and the processing operation related to the digital assistant may be performed by using an appropriate co-processing unit, so that the computing power of each processing unit is fully utilized, and the power consumption of the whole machine is reduced. In other words, an algorithm such as wake-up detection and echo cancellation and so on related to the digital assistant can be flexibly deployed on the target core, thereby fully utilizing the computing power and the memory resources on each core to complete the implementation of the function of the digital assistant, and running concurrently with the music and the call function. In addition, compared with a single-core centralized deployment mode, this manner can reduce the operation main frequency and the power consumption of the whole device is significantly reduced.

Embodiments of the present disclosure also provide a corresponding apparatus for implementing the above method or process. FIG. 6 illustrates an example structural block diagram of an apparatus 600 for data processing according to some embodiments of the present disclosure. The apparatus 600 may be implemented or included in the terminal device 110 and/or the smart hardware device 120. The various modules/components in the apparatus 600 may be implemented by hardware, software, firmware, or any combination thereof.

As shown in FIG. 6, the apparatus 600 includes a data scheduling module 610, configured to, in response to receiving the first speech data for the digital assistant, send the first speech data to a first co-processing unit associated with the digital assistant to perform processing on the first speech data; and receive the processed first speech data from the first co-processing unit. The apparatus 600 further includes a speech data determining module 620 configured to determine the encoded speech data based on the processed first speech data. The apparatus 600 further includes a response sending module 630 configured to send the encoded speech data to the digital assistant.

In some embodiments, the first co-processing unit is configured to perform echo cancellation, wake-up detection, and/or sound source localization on the first speech data.

In some embodiments, a second co-processing unit of the plurality of co-processing units is associated with a digital assistant, and the data scheduling module 610 is further configured to send the processed first speech data to the second co-processing unit to perform speech encoding on the processed first speech data, the second co-processing unit 224 being different from the first co-processing unit 222. The speech data determining module 620 is further configured to receive the encoded speech data from the second co-processing unit.

In some embodiments, the first co-processing unit is further configured to report the wake-up event to the main processing unit upon detecting the preset wake-up word, and the data scheduling module 610 is further configured to send the processed first speech data to the second co-processing unit in response to receiving the wake-up event from the first co-processing unit.

In some embodiments, the apparatus 600 further includes: a receiving module, configured to receive the second speech data for the first speech data from the digital assistant, where the second speech data is the reply of the digital assistant to the first speech data. The speech data determining module 620 is further configured to determine the decoded speech data based on the second speech data. The apparatus 600 further includes a playback controlling module configured to cause the decoded speech data to be played.

In some embodiments, the second co-processing unit of the plurality of co-processing units is associated with the digital assistant 114/124, and the speech data determining module 620 is further configured to: send the second speech data to the second co-processing unit 224 to perform speech decoding on the second speech data; and receive the decoded speech data from the second co-processing unit 224.

In some embodiments, the third co-processing unit of the plurality of co-processing units is associated with audio processing, and the data scheduling module 610 is further configured to: send the decoded speech data to the third co-processing unit to perform audio processing on the decoded speech data; and receive the processed decoded speech data from the third co-processing unit; the playback controlling module is further configured to cause the processed decoded speech data to be played.

In some embodiments, the receiving module is further configured to receive the audio data simultaneously with receiving the first speech data for the digital assistant 114/124. The apparatus 600 further includes an audio determination module configured to determine decoded audio data obtained after performing audio decoding on the audio data. The data scheduling module is further configured to send the decoded audio data to the third co-processing unit to perform audio processing on the audio data; and receive the processed audio data from the third co-processing unit 226.

The playback controlling module is further configured to cause the processed audio data to be played.

In some embodiments, a fourth co-processing unit of the plurality of co-processing units is associated with the instant call, and the receiving module is further configured to respond to receiving the third speech data for the instant call. The data scheduling module is further configured to send the third speech data to the fourth co-processing unit to perform noise reduction processing on the third speech data; receive the processed third speech data from the fourth co-processing unit. The sending module is further configured to send the processed third speech data to a receiver of the third speech data.

In some embodiments, the receiving module is further configured to receive the fourth speech data for the instant call simultaneously with receiving the first speech data for the digital assistant. The data scheduling module is further configured to send the fourth speech data to the fourth co-processing unit to perform processing corresponding to the instant call on the fourth speech data, and receive the processed fourth speech data from the fourth co-processing unit. The playback controlling module is further configured to cause the fourth speech data to be played.

In some embodiments, the apparatus 600 further includes a frequency adjusting module, configured to, in response to detecting a start of interaction with the digital assistant, change the operating frequency of the main processing unit 210 from the first operating frequency to the second operating frequency, the second operating frequency being higher than the first operating frequency; and in response to detecting an end of interaction with the digital assistant, changing the operating frequency of the main processing unit from the second operating frequency to the first operating frequency.

In some embodiments, the apparatus 600 further includes: a frequency adjusting module, configured to, in response to receiving the audio data, change the operating frequency of the main processing unit from the first operating frequency to the second operating frequency, the second operating frequency being higher than the first operating frequency; and in response to the end of the audio data playing, changing the operating frequency of the main processing unit from the second operating frequency to the first operating frequency.

In some embodiments, the apparatus 600 further includes: a frequency adjusting module, configured to, in response to detecting the start of the instant call, change the operating frequency of the main processing unit from the first operating frequency to the second operating frequency, the second operating frequency being higher than the first operating frequency and/or causing the fourth co-processing unit to be powered on; and in response to detecting the end of the instant call, change the operating frequency of the main processing unit from the second operating frequency to the first operating frequency and/or cause the fourth co-processing unit to be powered down.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standard products (ASSPs), system-on- chips (SOCs), complex programmable logic devices (CPLDs), and the like.

It should be understood that one or more of the steps of the above methods may be performed by a suitable electronic device or a combination of electronic devices. Such an electronic device or a combination of electronic devices may include, for example, the terminal device 110 and/or the smart hardware device 120 in FIG. 1.

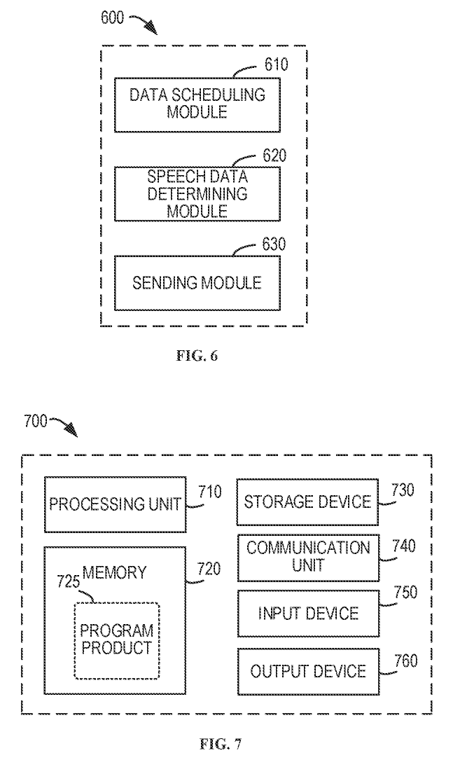

FIG. 7 illustrates a block diagram of an electronic device 700 in which one or more embodiments of the present disclosure may be implemented. It should be understood that the electronic device 700 illustrated in FIG. 7 is merely example and should not constitute any limitation on the functionality and scope of the embodiments described herein. The electronic device 700 shown in FIG. 7 may be configured to implement the terminal device 110, the smart hardware device 120, and/or the server device 130 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of the electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within the electronic device 700.

The electronic device 700 may further include additional removable/non-removable, volatile/non-volatile storage media. Although not shown in FIG. 7, a disk drive for reading or writing from a removable, non-volatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc. , communicate with one or more devices that enable the user to interact with the electronic device 700, or communicate with any device (e.g., a network card, a modem, etc. ) that enables the electronic device 700 to communicate with one or more other electronic devices. Such communication may be performed via an input/output (I/O) interface (not shown).

According to example implementations of the present disclosure, a main processing unit is provided, which is configured to execute to implement the method described above. According to example implementations of the present disclosure, a computer-readable storage medium is provided, on which computer-executable instructions are stored, wherein the computer-executable instructions are executed by a processor to implement the method described above. According to example implementations of the present disclosure, a computer program product is further provided, the computer program product is tangibly stored on a non-transitory computer-readable medium and includes computer-executable instructions, the computer-executable instructions are executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some implementations as an update, the functions noted in the blocks may also occur in a different order than that shown in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations as disclosed. Many modifications and variations will be apparent to those of ordinary skill in the art without departing from the scope and spirit of the various implementations illustrated. The selection of the terminology used herein is intended to best explain the principles of the implementations, practical applications, or improvements to techniques in the marketplace, or to enable others of ordinary skill in the art to understand the various implementations disclosed herein.

1. A method for data processing, comprising:
sending, at a main processing unit, and in response to receiving first speech data for a digital assistant, the first speech data to a first co-processing unit associated with the digital assistant to perform processing on the first speech data, the main processing unit being communicatively connected to a plurality of co-processing units comprising the first co-processing unit, the plurality of co-processing units being respectively configured to perform different processing operations;
receiving the processed first speech data from the first co-processing unit;
determining encoded speech data based on the processed first speech data; and
sending the encoded speech data to the digital assistant.

2. The method of claim 1, wherein the first co-processing unit is configured to perform echo cancellation, wake-up detection, and/or sound source localization on the first speech data.

3. The method of claim 1, wherein a second co-processing unit of the plurality of co-processing units is associated with the digital assistant, and wherein determining encoded speech data based on the processed first speech data comprises:
sending the processed first speech data to the second co-processing unit to perform speech encoding on the processed first speech data, the second co-processing unit being different from the first co-processing unit; and
receiving the encoded speech data from the second co-processing unit.

4. The method of claim 3, wherein the first co-processing unit is further configured to report a wake-up event to the main processing unit upon detecting a preset wake-up word, wherein sending the processed first speech data to the second co-processing unit comprises:
sending, in response to receiving the wake-up event from the first co-processing unit , the processed first speech data to the second co-processing unit.

5. The method of claim 1, further comprising:
receiving second speech data for the first speech data from an application running the digital assistant, the second speech data being a reply of the digital assistant to the first speech data;
determining decoded speech data based on the second speech data; and
causing the decoded speech data to be played.

6. The method of claim 5, wherein a second co-processing unit of the plurality of co-processing units is associated with the digital assistant, and determining decoded speech data based on the second speech data comprises:
sending the second speech data to the second co-processing unit to perform speech decoding on the second speech data; and
receiving the decoded speech data from the second co-processing unit.

7. The method of claim 5, wherein a third co-processing unit of the plurality of co-processing units is associated with audio processing, the method further comprising:
sending the decoded speech data to the third co-processing unit to perform audio processing on the decoded speech data;
receiving the processed decoded speech data from the third co-processing unit; and
causing the processed decoded speech data to be played.

8. The method of claim 7, further comprising:
determining, in response to receiving the audio data while receiving the first speech data for the digital assistant, the decoded audio data obtained after performing audio decoding on the audio data;
sending the decoded audio data to the third co-processing unit to perform audio processing on the audio data;
receiving the processed audio data from the third co-processing unit; and
causing the processed audio data to be played.

9. The method of claim 1, wherein a fourth co-processing unit of the plurality of co-processing units is associated with an instant call, the method further comprising:
sending, in response to receiving the third speech data for the instant call, the third speech data to the fourth co-processing unit to perform processing corresponding to the instant call on the third speech data;
receiving the processed third speech data from the fourth co-processing unit; and
sending the processed third speech data to a receiver of the third speech data.

10. The method of claim 9, further comprising:
sending, in response to receiving the fourth speech data for the instant call while receiving the first speech data for the digital assistant, the fourth speech data to the fourth co-processing unit to perform processing corresponding to the instant call on the fourth speech data;
receiving the processed fourth speech data from the fourth co-processing unit; and
causing the processed fourth speech data to be played.

11. The method of claim 1, further comprising:
changing, in response to detecting a start of interaction with the digital assistant, an operating frequency of the main processing unit from a first operating frequency to a second operating frequency, the second operating frequency being higher than the first operating frequency; and
changing, in response to detecting an end of interaction with the digital assistant, an operating frequency of the main processing unit from the second operating frequency to the first operating frequency.

12. The method of claim 8, further comprising:
changing, in response to receiving the audio data, an operating frequency of the main processing unit from a first operating frequency to a second operating frequency, the second operating frequency being higher than the first operating frequency; and
changing, in response to an end of the audio data playing, an operating frequency of the main processing unit from the second operating frequency to the first operating frequency.

13. The method of claim 9, further comprising:
changing, in response to detecting a start of the instant call, an operating frequency of the main processing unit from a first operating frequency to a second operating frequency, the second operating frequency being higher than the first operating frequency and/or causing the fourth co-processing unit to be powered on; and
changing, in response to detecting an end of the instant call, an operating frequency of the main processing unit from the second operating frequency to the first operating frequency and/or causing the fourth co-processing unit to be powered down.

14. An electronic device comprising:
at least one processing unit; and
at least one memory coupled to the at least one processing unit and storing instructions for execution by the at least one processing unit, wherein the instructions, when executed by the at least one processing unit, cause the electronic device to perform acts comprising:
sending, in response to receiving first speech data for a digital assistant, the first speech data to a first co-processing unit associated with the digital assistant to perform processing on the first speech data, the main processing unit being communicatively connected to a plurality of co-processing units comprising the first co-processing unit, the plurality of co-processing units being respectively configured to perform different processing operations;
receiving the processed first speech data from the first co-processing unit;
determining encoded speech data based on the processed first speech data; and
sending the encoded speech data to the digital assistant.

15. The electronic device of claim 14, wherein the first co-processing unit is configured to perform echo cancellation, wake-up detection, and/or sound source localization on the first speech data.

16. The electronic device of claim 14, wherein a second co-processing unit of the plurality of co-processing units is associated with the digital assistant, and wherein determining encoded speech data based on the processed first speech data comprises:
sending the processed first speech data to the second co-processing unit to perform speech encoding on the processed first speech data, the second co-processing unit being different from the first co-processing unit; and
receiving the encoded speech data from the second co-processing unit.

17. The electronic device of claim 14, wherein the acts further comprises:
receiving second speech data for the first speech data from an application running the digital assistant, the second speech data being a reply of the digital assistant to the first speech data;
determining decoded speech data based on the second speech data; and
causing the decoded speech data to be played.

18. The electronic device of claim 14, wherein a fourth co-processing unit of the plurality of co-processing units is associated with an instant call, the method further comprising:
sending, in response to receiving the third speech data for the instant call, the third speech data to the fourth co-processing unit to perform processing corresponding to the instant call on the third speech data;
receiving the processed third speech data from the fourth co-processing unit; and
sending the processed third speech data to a receiver of the third speech data.

19. The electronic device of claim 14, wherein the acts further comprises:
changing, in response to detecting a start of interaction with the digital assistant, an operating frequency of the main processing unit from a first operating to a second operating frequency, the second operating frequency being higher than the first operating frequency; and
changing, in response to detecting an end of interaction with the digital assistant, an operating frequency of the main processing unit from the second operating frequency to the first operating frequency.

20. A non-transitory computer-readable storage medium, having stored thereon a computer program executable by a processing unit to implement acts comprising:
sending, in response to receiving first speech data for a digital assistant, the first speech data to a first co-processing unit associated with the digital assistant to perform processing on the first speech data, the main processing unit being communicatively connected to a plurality of co-processing units comprising the first co-processing unit, the plurality of co-processing units being respectively configured to perform different processing operations;
receiving the processed first speech data from the first co-processing unit;
determining encoded speech data based on the processed first speech data; and
sending the encoded speech data to the digital assistant.
